(19) United States
(12) Patent Application Publication
(10) Pub. No.: US 2006/0228594 A1
(43) Pub. Date: Oct. 12, 2006

(54) Method for shutting down fuel cell and fuel cell system using the same

(76) Inventor: Dong Myung Suh, Yongin (KR)

Correspondence Address: CHRISTIE, PARKER & HALE, LLP, PO BOX 7068, PASADENA, CA, 91109-7068, US

(21) Appl. No.: 11/375,350

(22) Filed: Mar. 13, 2006

(30) Foreign Application Priority Data
Apr. 12, 2005 (KR) 2005-30511

(51) Int. Cl. H01M 16/00; H01M 8/04; H01M 8/10

(52) U.S. Cl. 429/9; 429/13; 429/23; 429/30; 429/22

(57) ABSTRACT

A method of shutting down a fuel cell system and a fuel cell system using the method include a fuel cell having an anode and a cathode attached to opposite sides of an electrolyte membrane and generating electric energy by-electrochemical reaction between a gaseous hydrogen-containing fuel and an oxidizing agent respectively supplied to the anode and the cathode. The method includes electrically disconnecting an external load from the fuel cell in response to a shutting down signal for the fuel cell, intercepting the gaseous fuel and the oxidizing agent, and electrically connecting output terminals coupled to the anode and the cathode of the fuel cell with respective terminals of a battery, each battery terminal having a same polarity as the coupled anode or cathode.

### CROSS-REFERENCE TO RELATED APPLICATION

This application claims priority to and the benefit of Korean Patent Application No. 10-2005-0030511, filed on Apr. 12, 2005, in the Korean Intellectual Property Office, the entire content of which is incorporated herein by reference.

### BACKGROUND

1. Field of the Invention

The present invention relates to a method for shutting down a fuel cell and a fuel cell system using the same, which can effectively remove unreacted fuel remaining in the fuel cell when the fuel cell is shut down.

2. Discussion of Related Art

A fuel cell is a power generation system that directly changes chemical reaction energy due to a reaction between hydrogen and oxygen into electrical energy, in which hydrogen is contained in hydro-carbonaceous material such as methanol, ethanol, natural gas or the like.

Fuel cells are classified into various types, such as a phosphate fuel cell, a molten carbonate fuel cell, a solid oxide fuel cell, a polymer electrolyte membrane fuel cell, an alkaline fuel cell, etc., according to the kind of electrolytes used. These types of fuel cells are operated on basically the same principles, but differ in the kind of fuel, the driving temperature, the catalyst, and the electrolyte, etc. from one another.

Among these fuel cells types, the polymer electrolyte membrane fuel cell (PEMFC) has advantages as compared with other fuel cells in that its output performance is excellent; its operation temperature is low; its start and response are quickly performed; and it can be widely used as a portable power source for an automobile, a distributed power source for a house and public places, a micro power source for electronic devices, etc.

The PEMFC includes a stack, a reformer, a fuel tank, and a fuel pump. The fuel pump supplies fuel from the fuel tank to the reformer, and the reformer reforms the fuel to generate hydrogen gas. The stack allows the hydrogen gas to electrochemically react with oxygen, thereby generating electrical energy.

Another of these fuel cell types is a direct methanol fuel cell (DMFC), which is similar to the PEMFC but different in that a liquid methanol fuel is directly supplied to the stack. In contrast to the PEMFC, the DMFC does not use a reformer so this type of fuel cell is favorable to miniaturization.

The stack for the fuel cell has a structure that several to several tens of unit cells, each including a membrane electrode assembly (MEA) and a separator, are stacked. Here, the MEA has a structure that an anode (so-called a “fuel electrode” or an “oxidation electrode”) and a cathode (so-called an “air electrode” or a “reduction electrode”) are attached to a polymer electrolyte membrane. Further, the separator has a structure that connects a plurality of MEAs in series, and supplies the fuel and the air to the MEAs.

When an electronic device using the fuel cell as a power source is turned off by a user, a controller, i.e., a micro-controller or a micom of the fuel cell controls the fuel pump to stop operating, thereby shutting down the fuel cell. However, when the fuel cell is shut down, oxygen still remains in the cathode and the fuel still remains in the anode. Here, the remaining oxygen oxidizes a catalyst layer or a catalyst supporting material. Further, the remaining fuel chemically reacts with the catalyst and the like and thus generates carbon dioxide, carbon monoxide, etc., thereby poisoning the catalyst layer. When the fuel cell is shut down, reactant fluids are unbalanced between the anode and the cathode of the fuel cell, so that the fluids undesirably move between the anode and the cathode. Thus, the conventional fuel cell system has problems that the catalyst layer and the catalyst supporting material are oxidized or corroded by the fuel and the oxidizing agent remaining when the fuel cell is shut down. In addition, the fluids internally remaining in the fuel cell deteriorate the performance of the fuel cell when it is restarted.

### SUMMARY OF THE INVENTION

Accordingly, various embodiments of the present invention provide a method for shutting down a fuel cell and a fuel cell system using the same, which can remove unreacted fuel and an oxidizing agent that remain in the fuel cell when the fuel cell is shut down, thereby not only decreasing adverse effects of when the fuel cell is restarted, but also effectively utilizing the unreacted and remaining fuel.

One embodiment involves a method of shutting down a fuel cell system that includes a fuel cell having an anode and a cathode attached to opposite sides of an electrolyte membrane and generating electric energy by electrochemical reaction between a gaseous hydrogen-containing fuel and an oxidizing agent respectively supplied to the anode and the cathode. The method includes electrically disconnecting an external load from the fuel cell in response to a shutting down signal for the fuel cell; intercepting the gaseous fuel and the oxidizing agent; and electrically connecting output terminals coupled to the anode and the cathode of the fuel cell with respective terminals of a battery, each having a same polarity as the coupled anode or cathode.

The method may also include measuring an output voltage of the fuel cell. Another embodiment includes electrically connecting the battery to the fuel cell when the output voltage of the fuel cell is equal to or greater than a reference voltage. One embodiment includes electrically connecting the fuel cell with a resistor when the output voltage of the fuel cell is lower than the reference voltage. The reference voltage may be obtained by multiplying a number of fuel cells in the fuel cell system by 0.2V. The method may further include controlling a switching part to allow a controller to selectively electrically connect the fuel cell with either the battery or the resistor.

A temperature of the battery may be sensed, and the battery may be electrically disconnected from the fuel cell when the sensed temperature is equal to or greater than a reference temperature.

One embodiment of the invention also includes exhausting the gaseous hydrogen-containing fuel and the oxidizing agent remaining in the fuel cell in response to the shutting down signal, and charging the battery while exhausting the gaseous hydrogen-containing fuel and the oxidizing agent remaining in the fuel cell.

Another embodiment of a fuel cell system according to the invention includes a fuel cell including an anode and a cathode attached to opposite sides of an electrolyte membrane, the fuel cell for generating electric energy by an electrochemical reaction between a gaseous hydrogen containing fuel and an oxidizing agent respectively supplied to the anode and the cathode; at least one reactant feeder to supply the gaseous fuel and the oxidizing agent to the fuel cell; a first switching part adapted to electrically disconnect an external load from the fuel cell in response to a first control signal; a second switching part adapted to electrically connect output terminals coupled to the anode and the cathode of the fuel cell with respective terminals of a battery, each battery terminal having a same polarity as the coupled anode or cathode, in response to a second control signal; and a controller coupled to the first switching part and the second switching part to generate the first control signal and the second control signal according to a shutting down signal. The external load may be provided by an application device.

In another embodiment, the controller is adapted to control the at least one reactant feeder to intercept the hydrogen containing fuel and the oxidizing agent in response to the shutting down signal, is adapted to transmit a third control signal to the at least one reactant feeder in response to the shutting down signal.

The fuel cell system can further include a voltage measurer adapted to measure an output voltage of the fuel cell, and to transmit information about the measured voltage to the controller. The voltage measurer, in one embodiment, is electrically connected to the output terminals only when measuring the output voltage of the fuel cell. In another embodiment, the controller is adapted to control the second switching part to connect an internal resistor with the fuel cell when the measured voltage is equal to or less than a reference voltage. The reference voltage may be obtained by multiplying a number of a number of fuel cells in the fuel cell system by 0.2V.

The fuel cell system may also include a temperature sensor that contacts one terminal of the battery and is adapted to sense a temperature of the battery, and to transmit information about the sensed temperature to the controller. A converter may be provided that includes the first switching part and the second switching part. A diode may also be coupled to an output terminal of the fuel cell such that current flowing from the battery or the external load to the fuel cell is substantially prevented.

### BRIEF DESCRIPTION OF THE DRAWINGS

These and/or other features and aspects of the invention will become apparent and more readily appreciated from the following description of examples of embodiments, taken in conjunction with the accompanying drawings of which:

FIG. 1 is a flowchart of a fuel cell shutting down method according to a first embodiment of the present invention;

FIG. 2 is a flowchart of a fuel cell shutting down method according to a second embodiment of the present invention;

FIG. 3 is a block diagram of a fuel cell system employing the fuel cell shutting down method according to an embodiment of the present invention; and

FIG. 4 illustrates schematically operations of the PEMFC usable in the fuel cell system of FIG. 3.

### DETAILED DESCRIPTION

Hereinafter, examples of embodiments of the present invention will be described with reference to the accompanying drawings, which can be easily appreciated by a person having an ordinary skill in the art.

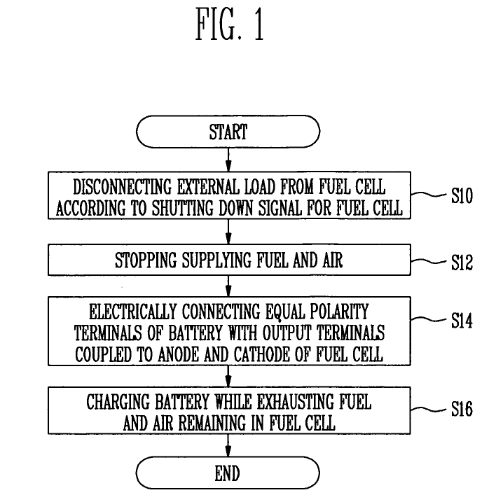

FIG. 1 is a flowchart of a fuel cell shutting down method according to a first embodiment of the present invention.

Referring to FIG. 1, the fuel cell shutting down method according to a first embodiment of the present invention is as follows. At operation S10 an external load is electrically disconnected from the fuel cell by a shutting down signal, thereby exhausting reactant fluids remaining in internal pipes of a fuel cell when the fuel cell is shut down. Here, the external load includes an application, e.g., a portable terminal, a notebook computer, and the like, which employ the fuel cell as a power source. Further, the shutting down signal denotes a predetermined signal that is generated when a user presses a shut-down button of the fuel cell or when the application is turned off, and transmitted to a controller of the fuel cell.

At operation S12, the reactant fluids, e.g., a hydrogen containing fuel and an oxidizing agent are prevented from being supplied to the fuel cell. In one embodiment, the hydrogen containing fuel includes methanol, and the oxidizing agent includes air or oxygen.

At operation S14, two output terminals coupled to an anode and a cathode of the fuel cell are electrically connected to equal polarity terminals of a battery. In other words, one output terminal coupled to the anode of the fuel cell is connected to the anode terminal of the battery, and the other output terminal coupled to the cathode of the fuel cell is connected to the cathode terminal of the battery.

At operation S16, the battery is charged with electric energy generated while exhausting the fuel and air remaining in the fuel cell. At this time, the battery can be used for supplying electric power to the controller, a pump and the like of the fuel cell when the fuel cell is initially driven. In this embodiment, the battery includes a secondary battery, which is rechargeable at least two times.

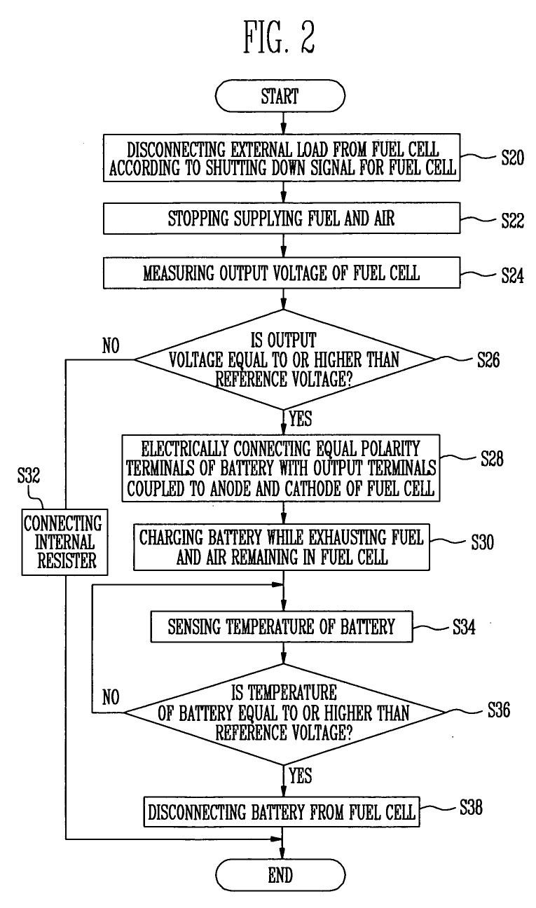

FIG. 2 is a flowchart of a fuel cell shutting down method according to a second embodiment of the present invention.

Referring to FIG. 2, the fuel cell shutting down method according to a second embodiment of the present invention is as follows. At operation S20 an external load is electrically disconnected from the fuel cell by a shutting down signal, thereby exhausting reactant fluids remaining in internal pipes of a fuel cell when the fuel cell is shut down.

At operation S22, the reactant fluids, e.g., a hydrogen containing fuel and an oxidizing agent, are prevented from being supplied to the fuel cell.

At operation S24, an output voltage of the fuel cell is measured. At operation S26, it is determined whether the measured output voltage is higher than a predetermined reference voltage. In this embodiment, the reference voltage is set as a chargeable voltage for the battery. For example, a voltage of 0.2V is set as the reference voltage per unit fuel cell. When the output voltage is equal to or higher than the reference voltage, at operation S28 the output terminals of the fuel cell are electrically connected to the equal polarity terminals of the battery. Then, at operation S30, the fuel and the air remaining in the fuel cell are exhausted and generate electric energy, thereby charging the battery with the electric energy.

At operation S32, when the output voltage is lower than the reference voltage, the output terminals of the fuel cell are connected with an internal resistor. Any resistor having a predetermined resistance value can be used as the internal resistor as long as it is connected to the anode and the cathode of the fuel cell and allowing electrons to move from the anode to the cathode. Further, the resistance value of the internal resistor is properly set to quickly exhaust the fuel and air remaining in the fuel cell when the fuel cell is shut down.

At operation S34, the temperature of the battery is sensed. Then, at operation S38, it is determined whether the sensed temperature is equal to or higher than a reference temperature. Such operations are performed to prevent the battery from being damaged by an overcharge or the like. In other words, according to the output of the fuel cell, or the capacity or the state of the battery, the battery may be fully charged before shutting down the fuel cell. In this case, the battery is likely to be damaged by the overcharge. Therefore, according to an embodiment of the present invention, a temperature sensing device, e.g., a temperature sensor being in contact with the battery, is used to prevent the battery from being damaged by an over charge or the like.

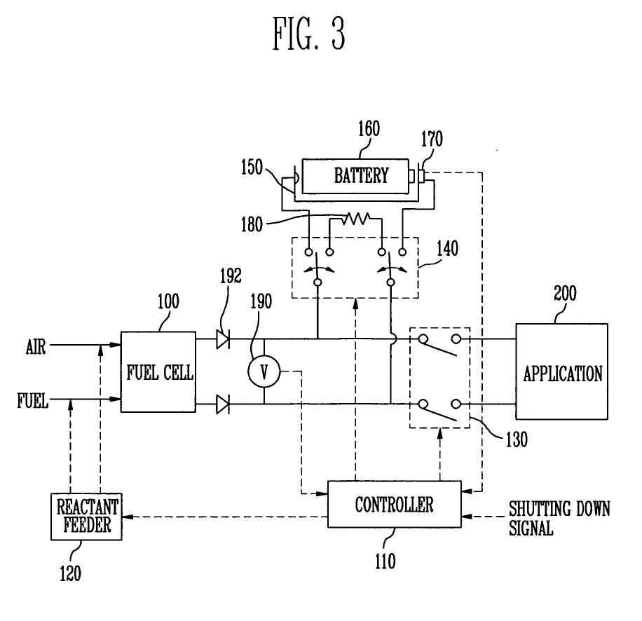

FIG. 3 is a block diagram of a fuel cell system employing the fuel cell shutting down method according to an embodiment of the present invention.

Referring to FIG. 3, the fuel cell system employing the fuel cell shutting down method prevents a catalyst layer or a catalyst layer supporting material from being oxidized or corroded by the fuel and air remaining in an internal pipe of a fuel cell 100, thereby maintaining the performance of the fuel cell when it is restarted. This embodiment of a fuel cell system includes the fuel cell 100, a controller 110, a reactant feeder 120, a first switching part 130, a second switching part 140, a battery housing 150, a battery 160, a temperature sensor 170, a resistor 180, a voltage measurer 190, and a diode 192.

In more detail, the fuel cell 100 receives a reactant, e.g., a liquid methanol fuel, and air, and generates electric energy due to the electrochemical reaction between the reactant and the air. The fuel cell 100 can be a PEMFC having a reformer to reform a hydrogen containing fuel, or a DMFC capable of directly supplying the liquid methanol fuel to a stack.

Further, the fuel cell 100 may be an active fuel cell supplying the fuel and air to an MEA by a pump or a blower, or a passive fuel cell supplying the fuel and air without the pump or the blower. In the case of the passive fuel cell, a fuel intercepting means, e.g., a valve or the like, may be provided to intercept the fuel and air to be supplied to the fuel cell 100.

The controller 110 generates a first control signal and a second control signal in response to a shutting down signal. The first control signal is transmitted to the first switching part 130, and the second control signal is transmitted to the second switching part 140. Further, the controller 110 generates a third control signal in response to the shutting down signal, and transmits the third control signal to the reactant feeder 120.

The controller 110 also receives a predetermined electric signal from the temperature sensor 170. The temperature sensor 170 senses the temperature of the battery 160 that contacts one terminal of the battery housing 150 and is inserted into the battery housing 150, thereby generating the electric signal having a level corresponding to the sensed temperature. Further, the electric signal may include a voltage and/or a current. The controller 110 is connected to an output terminal of the fuel cell 100, and receives another electric signal having a level corresponding to a voltage measured by the voltage measurer 190.

The controller 110 includes an oscillator to generate a predetermined control signal in response to the received electric signal, and a comparator to compare the sensed temperature and the measured voltage with a reference temperature and a reference voltage, respectively.

The reactant feeder 120 includes a pump or a blower to supply the fuel and air. Further, the reactant feeder 120 can include a valve and an operator to operate the valve according to the structures of the fuel cell. Also, the reactant feeder 120 intercepts the fuel and air supplied to the fuel cell 100 in response to the third control signal from the controller 110.

The first switching part 130 is provided between the fuel cell 100 and an application 200, and controls the fuel cell 100 to be connected to or disconnected from the application 200. Alternatively, the first switching part 130 may be integrally provided in a converter, e.g., a DC/DC converter placed between the fuel cell 100 and the application 200.

While the fuel cell 100 is operating, the first switching part 130 electrically connects the fuel cell 100 and the application 200, thereby supplying output electricity from the fuel cell 100 to the application 200. The first switching part 130 electrically disconnects the fuel cell from the application 200 in response to the first control signal.

The second switching part 140 is provided between the fuel cell 100 and the battery 160, and controls the fuel cell 100 to be connected to or disconnected from the battery 160. Alternatively, the second switching part 140 may be integrally provided in a converter, e.g., a DC/DC converter placed between the fuel cell 100 and the battery 160. The DC/DC converter may be provided as a single unit including both the first and second switching parts 130 and 140. Further, the DC/DC converter may be provided as two units, each including the first or second switching parts 130 and 140.

While the fuel cell 100 is operating, the second switching part 140 electrically connects the equal polarity terminals of the fuel cell 100 and the battery 200. With this configuration, the fuel and air remaining in the internal pipe of the fuel cell 100 are exhausted. Further, the electric energy generated at the same time is charged in the battery 160.

The battery 160 is inserted in the battery housing 150 and is electrically connected to the output terminal of the fuel cell 100 by the second switching part 140. One terminal of the battery housing 150 is in contact with the temperature sensor 170 to sense the temperature of the battery 160. The temperature sensor 170 includes a platinum resistance thermometer.

The resistor 180 is provided to smoothly shut down the fuel cell 100 when the output voltage of the fuel cell 100 is lower than the reference voltage. The resistor 180 includes an electric wire connecting the anode and the cathode of the fuel cell 100 and forming an electron passage. Further, the resistor 180 has a resistance suitable for quickly exhausting the fuel and air remaining in the internal pipe of the fuel cell 100.

The voltage measurer 190 measures the output voltage of the fuel cell 100. The voltage measurer 190 may act as another internal resistor in addition to the resistor 180, so that the voltage measurer 190 can be connected to the output terminal of the fuel cell 100 only when the output voltage is measured.

The diode 192 is provided adjacent to the output terminal of the fuel cell 100. The diode 192 prevents current from flowing in a direction from the battery 160 or the application 200 to the fuel cell 100.

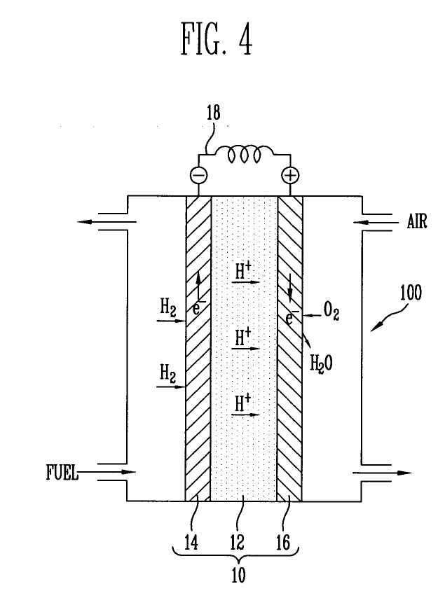

FIG. 4 illustrates operations of the PEMFC usable in the fuel cell system of FIG. 3.

Referring to FIG. 4, an MEA 10 of the fuel cell 100 includes a polymer electrolyte membrane 12, an anode 14, and a cathode 16. When hydrogen gas or a hydrogen containing fuel is supplied to the anode 14 of the fuel cell 100, electrochemical oxidation occurs in the anode 14, thereby ionizing hydrogen into a hydrogen ion H⁺ and an electron e⁻. The hydrogen ion moves from the anode 14 toward the cathode 16 through the membrane 12, and the electron moves from the anode 14 toward the cathode 16 through an external electric wire 18. In the cathode 16, the hydrogen ion electrochemically reacts with oxygen (reduction reaction), thereby producing reaction heat and water. At this time, electric energy is generated as the electron moves.

The foregoing fuel cell may be a PEMFC or a DMFC fuel cell. The electrochemical reactions in the PEMFC and the DMFC fuel cells are as follows, respectively.

[Reaction 1]

In the anode: H₂→2H⁺+2e⁻

In the cathode: 1/2O₂+2H⁺+2e⁻→H₂O

[Reaction 2]

In the anode: CH₃OH(g)+H₂O→CO₂+6H⁺+6e⁻

In the cathode: 3/2O₂+6H⁺+6e⁻→3H₂O

With this configuration, the unreacted fuel and air remaining in the internal pipe of the fuel cell are effectively removed when the fuel cell is shut down. Therefore, a catalyst layer, a catalyst layer supporting material, etc. of the fuel cell is prevented from being oxidized or corroded by the remaining fuel, thereby maintaining the performance of the fuel cell when it is restarted. Further, the electric energy generated by the remaining reactant is used for charging the battery, so that the fuel cell is more effectively utilized.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A method of shutting down a fuel cell system that comprises a fuel cell having an anode and a cathode attached to opposite sides of an electrolyte membrane and generating electric energy by electrochemical reaction between a gaseous hydrogen-containing fuel and an oxidizing agent respectively supplied to the anode and the cathode, the method comprising:
electrically disconnecting an external load from the fuel cell in response to a shutting down signal for the fuel cell;
intercepting the gaseous fuel and the oxidizing agent; and
electrically connecting output terminals coupled to the anode and the cathode of the fuel cell with respective terminals of a battery, each having a same polarity as the coupled anode or cathode.

2. The method according to claim 1, further comprising measuring an output voltage of the fuel cell.

3. The method according to claim 2, wherein the connecting the output terminals with the battery comprises electrically connecting the battery to the fuel cell when the output voltage of the fuel cell is equal to or greater than a reference voltage.

4. The method according to claim 3, further comprising electrically connecting the fuel cell with a resistor when the output voltage of the fuel cell is lower than the reference voltage.

5. The method according to claim 4, wherein the reference voltage is obtained by multiplying a number of fuel cells in the fuel cell system by 0.2V.

6. The method according to claim 4, wherein the connecting the battery with the fuel cell and the connecting the resistor with the fuel cell comprise controlling a switching part to allow a controller to selectively electrically connect the fuel cell with either the battery or the resistor.

7. The method according to claim 1, further comprising sensing a temperature of the battery, and electrically disconnecting the battery from the fuel cell when the sensed temperature is equal to or greater than a reference temperature.

8. The method according to claim 1, further comprising exhausting the gaseous hydrogen-containing fuel and the oxidizing agent remaining in the fuel cell in response to the shutting down signal.

9. The method according to claim 8, further comprising charging the battery while exhausting the gaseous hydrogen-containing fuel and the oxidizing agent remaining in the fuel cell.

10. A fuel cell system comprising:
a fuel cell comprising an anode and a cathode attached to opposite sides of an electrolyte membrane, the fuel cell for generating electric energy by an electrochemical reaction between a gaseous hydrogen containing fuel and an oxidizing agent respectively supplied to the anode and the cathode;
at least one reactant feeder to supply the gaseous fuel and the oxidizing agent to the fuel cell;
a first switching part adapted to electrically disconnect an external load from the fuel cell in response to a first control signal;
a second switching part adapted to electrically connect output terminals coupled to the anode and the cathode of the fuel cell with respective terminals of a battery, each battery terminal having a same polarity as the coupled anode or cathode, in response to a second control signal; and
a controller coupled to the first switching part and the second switching part to generate the first control signal and the second control signal according to a shutting down signal.

11. The fuel cell system according to claim 10, wherein the external load is provided by an application device.

12. The fuel cell system according to claim 10, wherein the controller is adapted to control the at least one reactant feeder to intercept the hydrogen containing fuel and the oxidizing agent in response to the shutting down signal.

13. The fuel cell system according to claim 12, wherein the controller is adapted to transmit a third control signal to the at least one reactant feeder in response to the shutting down signal.

14. The fuel cell system according to claim 10, further comprising a voltage measurer adapted to measure an output voltage of the fuel cell, and to transmit information about the measured voltage to the controller.

15. The fuel cell system according to claim 14, wherein the voltage measurer is electrically connected to the output terminals only when measuring the output voltage of the fuel cell.

16. The fuel cell system according to claim 14, wherein the controller is adapted to control the second switching part to connect an internal resistor with the fuel cell when the measured voltage is equal to or less than a reference voltage.

17. The fuel cell system according to claim 16, wherein the reference voltage is obtained by multiplying a number of a number of fuel cells in the fuel cell system by 0.2V.

18. The fuel cell system according to claim 10, further comprising a temperature sensor that contacts one terminal of the battery and is adapted to sense a temperature of the battery, and to transmit information about the sensed temperature to the controller.

19. The fuel cell system according to claim 10, further comprising a converter including the first switching part and the second switching part.

20. The fuel cell system according to claim 10, further comprising a diode coupled to an output terminal of the fuel cell such that current flowing from the battery or the external load to the fuel cell is substantially prevented.
